(19) United States
(12) Patent Application Publication
(10) Pub. No.: US 2020/0097964 A1
(43) Pub. Date: Mar. 26, 2020

(54) VALIDATING PARTNER FILES USING LOCAL RESOURCES

(71) Applicant: American Express Travel Related Services Company, Inc., New York, NY (US)

(72) Inventors: PUNIT KUMAR MITTAL, Phoenix, AZ (US); JOANNE L. SCHROEDL, Glendale, AZ (US); ANNE K. SCOTFORD, Scottsdale, AZ (US)

(73) Assignee: American Express Travel Related Services Company, Inc., New York, NY (US)

(21) Appl. No.: 16/141,691

(22) Filed: Sep. 25, 2018

(51) Int. Cl. G06Q 20/40; G06Q 20/14; G06Q 20/38

(52) U.S. Cl. CPC G06Q 20/401; G06Q 20/382; G06Q 20/14

(57) ABSTRACT

Systems and methods for validating partner files using local partner entity system resources are disclosed. The partner files may comprise profile files, daily files, or cycle files. The partner files may be validated locally on a partner entity system by invoking a validation engine. The validation engine may be configured to perform format validations and data validations on the partner files, and/or on individual data elements of each partner file. In response to determining a validation error in either the format validation or the data validation, the validation engine may generate a validation report comprising data regarding the validation error.

### FIELD

The disclosure generally relates to partner files transferred from a partner entity system to a transaction account issuer, and more specifically, to systems and methods for validating partner files using local resources of the partner entity system.

### BACKGROUND

Transaction account issuers may partner with various partner entities (e.g., global banks, third party financial institutions, etc.) for the partners to issue transaction instruments or accounts for the transaction account issuer. The transaction account issuer may provide data, analytics, and reporting to each partner entity system. For example, each partner entity system may transmit one or more partner files to the transaction account issuer. The partner file may be a profile file, a daily file, a cycle file, or the like. The transaction account issuer may process the partner files, run database queries based on the partner files, and report back data analytics, issues, or the like. In order to be properly processed, each partner file may need certain data elements having specified content, formats, or the like.

Partner entities may desire to test the partner file to ensure that the file can be properly processed by the transaction account issuer, and contains the needed data elements, content, formats, or the like. Typically, partner entities upload and transfer partner files to the transaction account issuer. The transaction account issuer then tests the partner file. In response to testing the partner file and determining one or more errors, the transaction account issuer may transmit back a report of the errors. The testing process may be lengthy as iterations of files are transmitted between the parties, and effort and resources to manually test the partner files are repeated. Further, the testing process may be delayed due to globally scattered resources and teams of testers. A technical problem is that the transmission of partner files from the partner entity system may be resource intensive, tying up bandwidth at the partner entity system and potentially causing transmission issues. Another technical problem is that testing the partner file on the transaction account issuer side further ties up computing and memory resources. Moreover, testing the partner file may need human review and input for lengthy periods of time, resulting in elongated partner onboarding and delayed data, analytics, and report delivery to each partner entity.

### SUMMARY

Systems, methods, and articles of manufacture (collectively, the “system”) for validating partner files are disclosed. The system may receive a partner file selection comprising data indicating the location of the partner file in the partner entity system. The system may interrogate the partner file locally on the partner entity system to determine a data element in the partner file. The system may perform a format validation on the data element to determine whether at least one of the data element or the partner file is formatted according to a file specification. The system may perform a data validation on the data element to determine whether the data element comprises data according to the file specification. The system may generate a validation report comprising data indicating an error in the data element detected during at least one of the format validation or the data validation.

In various embodiments, the system may retrieve a format validation parameter based on the data element of the partner file, wherein the format validation parameter comprises at least one of a partner file format specification, a partner file requirement type parameter, a data element order parameter, a data element requirement type parameter, a defined data element characteristic, or a custom format parameter. The step of performing the format validation may comprise determining whether at least one of data or metadata from the data element matches the format validation parameter.

In various embodiments, the system may retrieve a data validation parameter based on the data element of the partner file, wherein the data validation parameter comprises at least one of a data definition parameter, a data correlation parameter, or a custom data parameter. The step of performing the data validation may comprise determining whether data from the data element matches the data validation parameter.

In various embodiments, the system may parse the partner file to determine whether the partner file is empty or unreadable. The partner file may comprise at least one of a profile file, a daily file, or a cycle file.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for validating partner files, in accordance with various embodiments;

FIG. 2 is a block diagram illustrating various components of an exemplary validation engine for a system for validating partner files, in accordance with various embodiments;

FIG. 3 illustrates a process flow for a method of validating a partner file, in accordance with various embodiments;

FIG. 4 illustrates a process flow for a method of validating format in a partner file, in accordance with various embodiments; and

FIG. 5 illustrates a process flow for a method of validating data in a partner file, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

In various embodiments, systems, methods, and articles of manufacture (collectively, the “system”) for validating partner files are disclosed. The system may provide a validation engine that tests and validates various partner files, including profile files, daily files, cycle files, or the like. The validation engine may provide a web-enabled portal enabling global access to partner entities located anywhere in the world. The testing and validation may be performed on demand and at any time by partner entities using primarily local partner entity system computing resources. The testing and validation may be performed without needing to upload the partner file to a backend system or server for processing, and without needing human intervention. In that regard, the validation engine may interrogate the partner file locally on the partner entity system, and provide faster feedback and reporting of formatting and data errors in the partner file.

The system further improves the functioning of the computer (e.g., both at the partner entity system and at the transaction account issuer) by providing technical solutions to the technical problems caused by the transmission of partner files from the partner entity system to the transaction account issuer system. For example, by processing and validating partner files locally using partner entity system resources, the partner entity system uses less bandwidth, reduces transmission errors caused by transmitting the partner file to remote locations, and reduces server side storage requirements (e.g., by at least a gigabyte (GB) per a partner integration). Further, the transaction account issuer performs less computer functions, provides less input, and reduces manually intervention and validation, which saves on data storage and memory usage and reduces CPU processing (and human resource) needs. In that respect, a plurality of days may be saved for each partner file iteration, as immediate feedback is delivered to the partner entity (wherein a typical partner onboarding or partner file optimization may take at least 40-50 test file iterations).

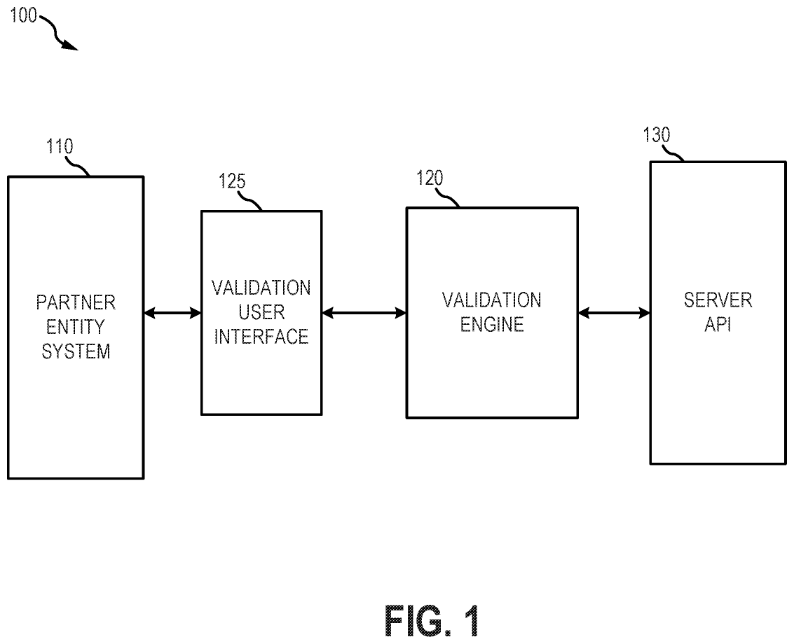

In various embodiments, and with reference to FIG. 1, a system 100 for validating partner files is disclosed. System 100 may comprise one or more of a partner entity system 110, a validation engine 120, a validation user interface (“UI”) 125, and/or a server application programming interface (API) 130. System 100 may also contemplate uses in association with web services, utility computing, pervasive and individualized computing, security and identity solutions, autonomic computing, cloud computing, commodity computing, mobility and wireless solutions, open source, biometrics, grid computing, and/or mesh computing.

In various embodiments, partner entity system 110 may be in electronic communication with validation UI 125. Partner entity system 110 may comprise a global or regional bank, third party financial institution, or the like having a relationship or partnership with a payment network. For example, partner entity system 110 may partner with the payment network to issue transaction instruments (e.g., to issue transaction instruments in regions where the payment network may not have a presence). In various embodiments, partner entity system 110 may partner with the payment network to issue corporate credit cards, transaction instruments, or the like. Partner entity system 110 may be configured to generate and transmit a partner file to the payment network via server API 130, as discussed further herein. Server API 130 may be configured to receive and process the partner file, execute database queries based on the partner file, and report back to partner entity system 110 data analytics, issues, or the like. In order to be properly processed by server API 130, each partner file may need to comprise certain data elements having specified content, formats, or the like. In that respect, the partner file may be formatted according to various file specifications from server API 130 (e.g., specified by the payment network). For example, the file specification may define the data elements that need to be included in each partner file (e.g., mandatory, optional, conditional, etc.), data formatting requirements of each data element (e.g., a date format, a currency format, all numerals, all letters, alphanumeric, etc.), required data in a data element (e.g., a fixed data field), a data minimum length, maximum length, exact length, a custom element requirement, and/or the like. As discussed further herein, partner entity system 110 may be configured to generate the partner file and validate the partner file via validation engine 120 to ensure that the generated partner file meets the requirements of the file specification.

Partner entity system 110 may be configured to generate the partner file in response to any suitable event. For example, in response to first establishing a relationship or partnership with the payment network, partner entity system 110 may generate the partner file to determine whether the partner file meets file specifications set forth by server API 130. As a further example, in response to updating or changing a backend system, application, process, or the like, partner entity system 110 may generate the partner file to determine whether the update or change impacts formatting, data quality, or the like in the partner file. As a further example, in response to server API 130 introducing new or revised file specifications, partner entity system 110 may generate the partner file to determine whether the partner file meets the new or revised file specifications. In various embodiments, partner entity system 110 may generate the partner file in a test environment or a production environment.

In various embodiments, partner entity system 110 may be configured to generate the partner file comprising test data (e.g., randomly generated data, pre-generated data, etc.) and/or production data (e.g., data generated within the scope of business). The partner file may comprise one or more data elements. Each data element may comprise partner file data or metadata, such as, for example, an element identifier (e.g., an element name, an element ID, etc.), an element type (e.g., data, currency, etc.), a data value, a value length, an element dependency (e.g., element ID “X” is dependent on the existence of element ID “Y”), and/or the like. The partner file may comprise any suitable file format, such as, for example XML, TXT, RTF, a flat file format (e.g., CSV, delimited, etc.), or the like.

In various embodiments, the partner file may comprise a profile file, a daily file, and/or a cycle file. For example, and in accordance with various embodiments, the profile file may comprise data corresponding to partner entity system 110 and clients of partner entity system 110, transaction account holders from transaction instruments issued by clients of partner entity system 110, or the like. The profile file may comprise, for example, a client entity ID, a client entity name, a client entity address, and/or any other suitable data regarding the client of partner entity system 110; a transaction account number, a transaction account status (e.g., canceled, active, etc.), a transaction account holder name, a transaction account hierarchy structure (e.g., for a corporate transaction account), a transaction account holder billing information (e.g., address, phone number, etc.), and/or any other suitable data regarding the transaction account holder; and/or the like. As a further example, and in accordance with various embodiments, the daily file may comprise daily transaction data and aging data. For example, the daily file may comprise data such as transaction account payments, transaction account (or bank) fees and adjustments, purchases, credits, transaction data (e.g., transaction currency, merchant identifier, billing amount, airline ticket details, hotel booking information, car rental details, etc.), and the like, and/or aging accounts, transactions, balances, and the like. As a further example, and in accordance with various embodiments, the cycle file may comprise cycle transactions and cycle aging data. For example, the cycle file may comprise data regarding transactions (e.g., sale of goods, etc.) completed during a defined time period (e.g., the cycle), such as account balances, payments, account (or bank) fees and adjustments, credits, transaction data, and the like, and/or aggregate aging accounts, transactions, balances, and the like. In various embodiments, each partner file may comprise header and trailer records, including, for example, partner entity details, quality control features, file balancing features, or the like (e.g., number of records, total billing amount, etc.).

In various embodiments, partner entity system 110 may comprise one or more software, hardware, and/or database components. For example, partner entity system 110 may comprise one or more network environments, servers, computer-based systems, processors, databases, and/or the like. Partner entity system 110 may comprise at least one computing device in the form of a computer or processor, or a set of computers/processors, although other types of computing units or systems may be used, such as, for example, a server, web server, pooled servers, or the like. Partner entity system 110 may also include one or more data centers, cloud storages, or the like, and may include software, such as APIs, configured to perform various operations discussed herein. In various embodiments, partner entity system 110 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

In various embodiments, validation engine 120 may comprise software, an API, a SDK, a web interface, or the like accessible from partner entity system 110, via validation UI 125. Validation engine 120 may comprise an API integrating JAVA® and JAVASCRIPT® modules to execute one or more validations related to partner file characteristics (e.g., file size, file type, file format, etc.), data format, content, and/or quality. For example, validation engine 120 may comprise a JSON rules engine configured to perform various validation operations on a partner file, as discussed further herein. In that regard, validation engine 120 may be configured to validate the partner file locally in partner entity system 110 systems and using computing resources from partner entity system 110. In that regard, validation engine 120 may be supplied to partner entity system 110 and accessible by partner entity system 110 via a web interface or the like.

Partner entity system 110 may access validation engine 120 via validation UI 125. In that regard, validation UI 125 may include a graphical user interface (“GUI”) configured to enable a user to interact with validation engine 120. For example, the user (and/or partner entity system 110 via an automated process) may interact validation engine 120 to select one or more partner files to be validated by validation engine 120. In response to validation engine 120 receiving the selection of a partner file (e.g., in response to validation engine 120 being invoked), validation engine 120 may be invoked to locally validate the partner file, as discussed further herein. In response to locally validating the partner file, validation engine 120 may be invoked to generate a validation report (e.g., using an API), as discussed further herein.

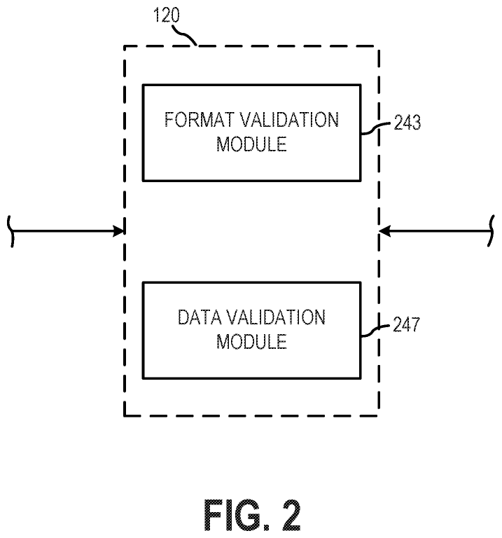

In various embodiments, validation engine 120 may comprise one or more systems, engines, components, or the like configured to validate one or more aspects of the partner file. For example, and with reference to FIG. 2, validation engine 120 may comprise a format validation module 243 and a data validation module 247.

In various embodiments, format validation module 243 may be configured to validate the format of partner files and/or individual data elements in each partner file. Format validation module 243 may comprise any suitable combination of software and/or database components. Format validation module 243 may be configured to store and maintain various format validation parameters corresponding to data format requirements of the file specification, as discussed further herein. The format validation parameters may be specific to one or more data elements, based on the element identifier. Format validation module 243 may be configured to validate the data element and/or partner file by determining whether the data element metadata, tags, or the like, or data from the data element or partner file, match the format validation parameter (e.g., satisfies the format validation parameter).

In various embodiments, data validation module 247 may be configured to validate the data content, quality, and the like of partner files and/or individual data elements in each partner file. Data validation module 247 may comprise any suitable combination of software and/or database components. Data validation module 247 may be configured to store and maintain various data validation parameters corresponding to data content and quality requirements of the file specification, as discussed further herein. In that regard, the data validation parameter may be specific to one or more data elements or partner files, based on the element identifier. Data validation module 247 may be configured to validate the data element by determining whether data from the data element matches the data validation parameter (e.g., satisfies the data validation parameter).

In various embodiments, the validation parameters may be configurable in validation engine 120 (e.g., in the JSON rule engine). For example, in response to a partner file specification changing, modifications to one or more validation parameters may be made in validation engine 120 to accommodate the new (or revised) validation requirements. The validation parameters may be configured (e.g., modified, added, removed, etc.) using a programming language, or may be configured via a user interface. In various embodiments, partner entity system 110, via validation UI 125, may access validation engine 120 to configure one or more validation parameters. In various embodiments, server API 130 may access validation engine 120 to configure one or more validation parameters. In that regard, the validation parameters may be configurable such that validation engine 120 may be used to validate any suitable file, without needing a backend update in server API 130.

In various embodiments, and with reference again to FIG. 1, server API 130 may be in electronic communication with validation engine 120. Server API 130 may be configured to transmit file specifications, revised file specification, and/or file specification updates to validation engine 120. Server API 130 may comprise any suitable combination of hardware, software, and/or database components. For example, server API 130 may comprise one or more network environments, servers, computer-based systems, processors, databases, and/or the like. Server API 130 may comprise at least one computing device in the form of a computer or processor, or a set of computers or processors, although other types of computing units or systems may be used, such as, for example, a server, web server, pooled servers, or the like. Server API 130 may also include one or more data centers, cloud storages, or the like, and may include software, such as APIs, configured to perform various operations discussed herein. In various embodiments, server API 130 may be located within a payment network such as, for example, AMERICAN EXPRESS®, VISANET®, MASTERCARD®, DISCOVER®, INTERAC®, Cartes Bancaires, JCB®, private networks (e.g., department store networks), and/or any other payment network, transaction network, or the like. In various embodiments, server API 130 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

As used herein, “transmit” may include sending at least a portion of electronic data from one system component to another. Additionally, as used herein, “data,” “information,” “audio signal,” or the like may include encompassing information such as commands, queries, files, messages, data for storage, and the like in digital or any other form.

As used herein, “electronic communication” may comprise a physical coupling and/or non-physical coupling capable of enabling one or more system components to transmit and receive data. For example, “electronic communication” may refer to a wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac/ad/ah/af signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZIGBEE® protocol maintained by the ZigBee alliance), a cellular protocol, an infrared protocol, an optical protocol, or any other protocol capable of transmitting information via a wired or wireless connection.

One or more of the system components may be in electronic communication via a network. As used herein, the term “network” may further include any cloud, cloud computing system, or electronic communications system or method that incorporates hardware and/or software components. Communication amongst the one or more system components may be accomplished through any suitable communication channels, such as, for example, a telephone network, an extranet, an intranet, internet, point of interaction device (personal digital assistant, cellular phone, kiosk, tablet, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using Internetwork Packet Exchange (IPX), APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

The various system components may be independently, separately or collectively suitably coupled to the network via data links which includes, for example, a connection to an internet service provider (ISP) over the local loop as is typically used in connection with standard modem communication, cable modem, DISH NETWORKS®, ISDN, DSL, or various wireless communication methods. It is noted that the network may be implemented as other types of networks, such as an interactive television (ITV) network. Moreover, the system contemplates the use, sale, or distribution of any goods, services or information over any network having similar functionality described herein.

A network may be unsecure. Thus, communications over the network may utilize data encryption. Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

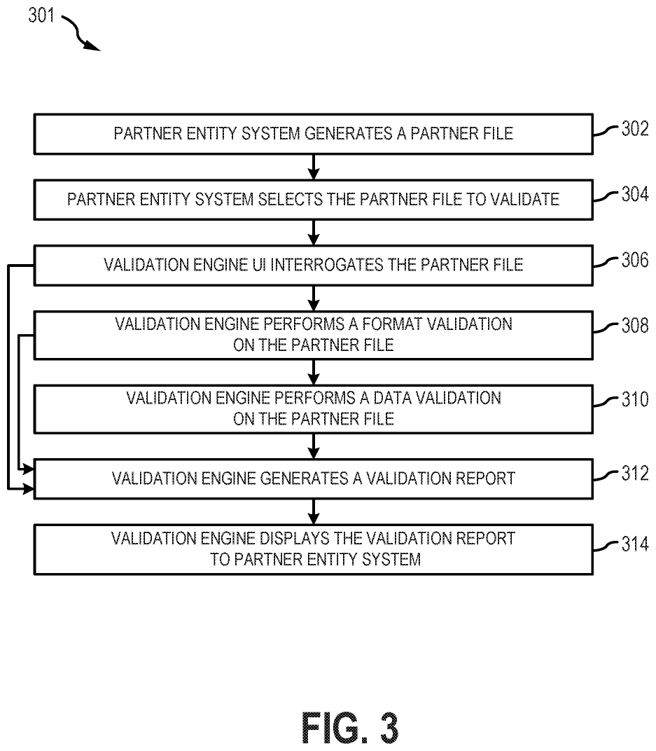

Referring now to FIGS. 3-5 the process flow depicted is merely an embodiment and is not intended to limit the scope of the disclosure. For example, the steps recited in any of the method or process descriptions may be executed in any order and are not limited to the order presented. It will be appreciated that the following description makes appropriate references not only to the steps and elements depicted in FIGS. 3-5, but also to the various system components as described above with reference to FIGS. 1 and 2. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below. Unless otherwise specifically noted, articles depicted in the drawings are not necessarily drawn to scale.

With specific reference to FIG. 3, a method 301 for validating partner files is disclosed. In various embodiments, partner entity system 110 generates a partner file (step 302). The partner file may be generated in a test environment, in a production environment, or the like. For example, partner entity system 110 may build an extraction process from local systems, using SQL or other data extraction protocols, to retrieve the desired (or required) data elements from the local systems. The partner file may comprise a profile file, a daily file, or a cycle file. Data within each partner file may be formatted in accordance with file specifications set forth by server API 130.

Partner entity system 110 may be configured to generate the partner file to ensure that the generated partner file meets the requirements of the file specification. For example, in response to first establishing a relationship or partnership with the payment network, partner entity system 110 may generate the partner file for use in determining whether the partner file meets file specifications set forth by server API 130. As a further example, in response to updating or changing a backend system, application, process, or the like, partner entity system 110 may generate the partner file for use in determining whether the update or change impacts formatting, data quality, or the like in the partner file. As a further example, in response to server API 130 introducing new or revised file specifications, partner entity system 110 may generate the partner file for use in determining whether the partner file meets the new or revised file specifications.

Partner entity system 110 may access validation UI 125 to begin the validation process. In that respect, validation UI 125 may perform a security check on partner entity system 110 prior to granting access. For example, validation UI 125 may prompt partner entity system 110 to provide access credentials (e.g., username, password, biometric input, etc.) and/or the like to ensure that partner entity system 110 has registered with the payment network associated with server API 130, prior to accessing validation engine 120.

Partner entity system 110 selects the partner file to validate (step 304) using validation UI 125. For example, the partner entity may select the partner file by indicating the location of the partner file in partner entity system 110 (e.g., the database, memory location, or the like where the partner file is stored). In that regard, a transmission or upload of the partner file does not need to take place, as the partner file is instead accessed locally in partner entity system 110.

Validation engine 120 interrogates the partner file (step 306) locally on partner entity system 110. Validation engine 120 may parse the partner file to determine whether the partner file is empty (e.g., zero bytes) or unreadable. In response to determining that the partner file is empty or unreadable, validation engine 120 may generate a zero byte error record. The zero byte error record may be displayed to partner entity system 110, via validation UI 125, and/or may be included in a generated validation report (e.g., step 312), as discussed further herein.

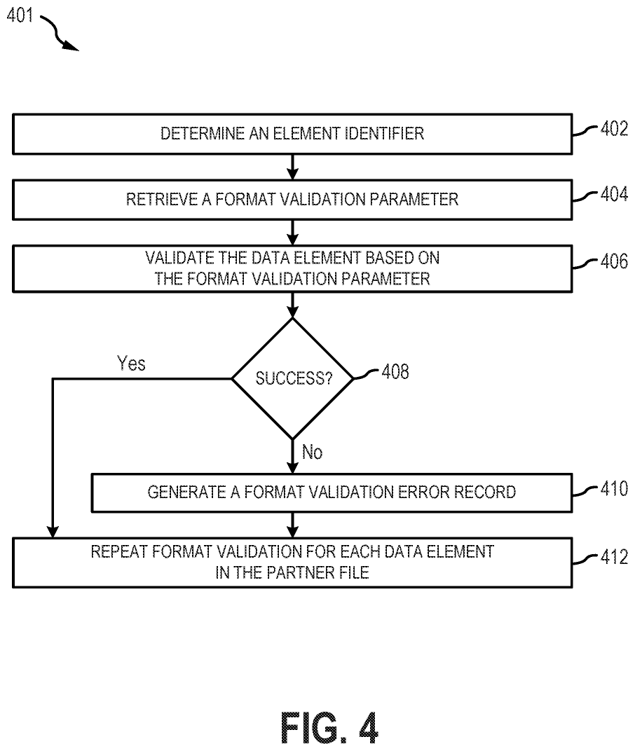

In various embodiments, validation engine 120 performs a format validation on the partner file (step 308). Validation engine 120 may perform the format validation using any suitable method. For example, validation engine 120 may perform the format validation on the data element to determine whether the data element or the partner file is formatted according to the file specification (e.g., as specified by server API 130). For example, and with reference to FIG. 4, a method 401 for validating format of partner files is disclosed.

In various embodiments, format validation module 243 determines an element identifier (step 402). Format validation module 243 may parse the partner file to determine the data elements contained therein. Each data element may comprise metadata, tags, or the like indicating the element identifier. Format validation module 243 retrieves a format validation parameter (step 404) based on the element identifier. The format validation parameter may comprise any suitable parameter regarding a data format requirement from the file specification. In that regard, the format validation parameter may be specific to one or more data elements, based on the element identifier. For example, the format validation parameter may comprise a file format specification (e.g., the partner file format specified by the file specification, a file maximum file size, etc.), a file requirement type parameter (e.g., the partner file may comprise required data elements), a data element order parameter (e.g., data elements in the partner file may be required to be in a specified order), a data element requirement type parameter (e.g., “mandatory,” “optional,” “conditional,” etc.), a defined data element characteristic (e.g., a data format, a data minimum length, a data maximum length, a data type, data headers or trailers, etc.), and/or a custom format parameter (e.g., a data element may comprise a custom format parameter unique to one or more data elements).

In various embodiments, format validation module 243 validates the data element based on the format validation parameter (step 406). Format validation module 243 may validate the data element by determining whether the data element metadata, tags, or the like, or data from the data element, satisfies the format validation parameter (e.g., matches the format validation parameter). For example, format validation module 243 may begin by validating the data element requirement type parameter for all “mandatory” data elements. In that regard, in response to a “mandatory” data element not existing within the partner file, the validation will fail. As a further example, wherein the format validation parameter comprises a defined data element characteristic having a data minimum length of “5 characters” and the data element comprises a value of “ABC,” the validation will fail. As a further example, wherein the format validation parameter comprises a data element requirement type parameter of “conditional” and the data element is conditional on element identifier “123,” in response to the partner file comprising a data element having an element identifier of “123”, the validation will succeed.

In response to the format validation failing (step 408), format validation module 243 generates a format validation error record (step 410). The format validation error record may comprise data indicating one or more validation parameters that the data element did not satisfy. The format validation error record may comprise an error record ID; may specify the location of the data element that did not pass format validation, such as, for example, a line number, a message number, or the like; and may specify the format validation parameter that did not pass validation. In response to generating the format validation error record, and in accordance with various embodiments, format validation module 243 repeats the format validation for each data element in the partner file (step 412). In response to the format validation succeeding (step 408), format validation module 243 repeats the format validation for each data element in the partner file (step 412). In that respect, the format of all data elements in the partner file, individually and collectively, may be validated.

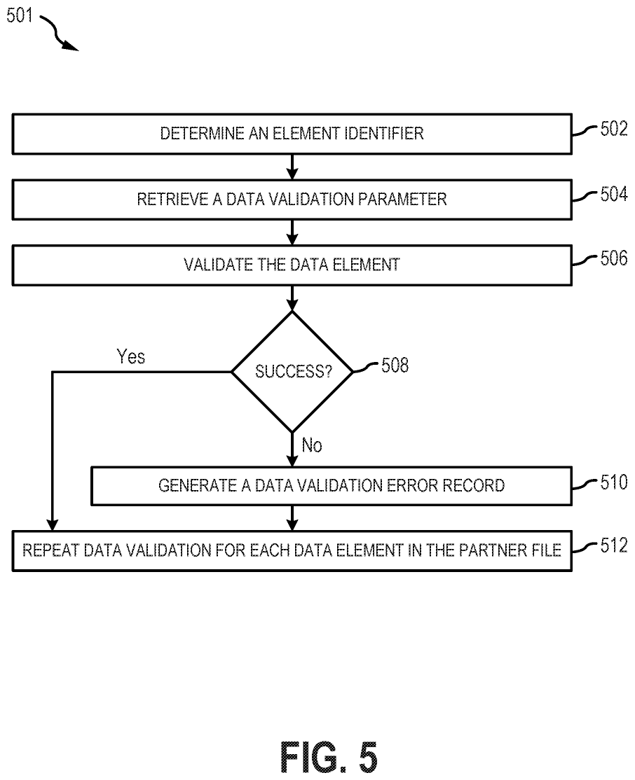

In various embodiments, and with reference again to FIG. 3, validation engine 120 performs a data validation on the partner file (step 310). Validation engine 120 may perform the data validation using any suitable method. For example, validation engine 120 may perform the data validation on the data element to determine whether at least one of the data elements in the partner file is valid based on the data validation parameters (e.g., the data element is formatted according to the file specification specified by server API 130). For example, and with reference to FIG. 5, a method 501 for validating data in a partner file is disclosed.

In various embodiments, data validation module 247 determines an element identifier (step 502). Data validation module 247 may parse the partner file to determine the data elements contained therein. Each data element may comprise metadata, tags, or the like indicating the element identifier. Data validation module 247 retrieves a data validation parameter (step 504) based on the element identifier. The data validation parameter may comprise any suitable parameter regarding a data content requirement, a data quality requirement, or the like. For example, the data validation parameter may be specified in the file specification from server API 130. In that regard, the data validation parameter may be specific to one or more data elements or partner files, based on the element identifier. For example, the data validation parameter may comprise a data definition parameter (e.g., data in the data element meets the definition of the data element as published in the file specification), such as, for example, a date parameter, a time parameter, a currency code parameter, a country code parameter, a record sequence parameter, a partner detail parameter, a pre-defined value parameter, a balancing parameter (e.g., record counts, file balancing, etc.), or the like. As a further example, the data validation parameter may comprise a data correlation parameter. The data correlation parameter may be configured to ensure that data residing in a first data element does not conflict with data residing in a second data element that is correlated to the first data element. As a further example, the data validation parameter may comprise a custom data parameter. The custom data parameter may be configured to ensure that data across various data elements, and/or across one or more partner files, are consistent and working together properly. In various embodiments, the data validation parameter (e.g., the custom data parameter) may also be configured by server API 130 specific to one or more partner entity systems 110. For example, the custom data parameter may comprise partner-specific configurations that may be used to validate a custom data parameter and/or a partner-specific validation rule.

In various embodiments, data validation module 247 validates the data element based on the data validation parameter (step 506). Data validation module 247 may validate the data element by determining whether data from the data element matches the data validation parameter (e.g., satisfies the data validation parameter). For example, wherein a first data element corresponding to an “account status” comprises a value of “cancelled collection.” A second data element corresponding to a “collection data” is conditionally related to the first data element and is populated with a valid date, the data correlation parameter may validate successfully.

In response to the data validation failing (step 508), data validation module 247 generates a data validation error record (step 510). The data validation error record may comprise data indicating one or more data parameters that the data element did not satisfy. The data validation error record may comprise an error record ID; may specify the location of the data element that did not pass data validation, such as, for example, a line number, a message number, or the like; and may specify the data validation parameter that did not pass validation. In response to generating the data validation error record, and in accordance with various embodiments, data validation module 247 repeats the data validation for each data element in the partner file (step 512). In response to the data validation succeeding (step 508), data validation module 247 repeats the data validation for each data element in the partner file (step 512). In that respect, the data content, data quality, and the like of all data elements in the partner file may be validated.

In various embodiments, and with reference again to FIG. 3, validation engine 120 generates a validation report (step 312). The validation report may comprise data regarding errors detected, and/or failed validations, during the validation process. For example, the validation report may comprise one or more of the zero byte error record, the format validation error record, the data validation error record, or the like. The validation report may be generated at any suitable time, such as, for example, in response to a zero byte error record being generated (e.g., step 304), to a format validation being completed (e.g., step 308), to a data validation being completed (e.g., step 310), and/or at any other suitable or desired time. Validation engine 120 displays the validation report to partner entity system 110 (step 314), via validation UI 125. As a further example, the validation report may be downloaded by partner entity system 110 (e.g., validation engine 120 transmits the validation report to partner entity system 110, using any suitable file format).

In various embodiments, server API 130 may be configured to monitor and gather data regarding the validation process. For example, server API 130 may be configured to provide the validation data to the associated payment network for internal tracking and use. In that regard, server API 130 may be configured to perform a big data analysis on the validation data to determine incorrect format validation parameters and/or data validation parameters, to identify the success or failure rate of various partner entity systems 110 at varying levels of readiness (e.g., onboarding stage), and to enhance the validation process.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements such as, for example, (i) a transaction account and (ii) an item (e.g., offer, reward points, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input, and/or any other method known in the art.

The terms “payment vehicle,” “transaction account,” “financial transaction instrument,” “transaction instrument” and/or the plural form of these terms may be used interchangeably throughout to refer to a financial instrument. Phrases and terms similar to “transaction account” may include any account that may be used to facilitate a financial transaction. The financial instrument may be used as part of a transaction, such as a purchase, and may be a charge card, credit card, debit card, awards card, prepaid card, telephone card, smart card, magnetic stripe card, bar code card, transponder, radio frequency card, and/or the like corresponding to a transaction account and/or transaction account number.

Phrases and terms similar to “account,” “account number,” “account code” or “transaction account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a financial instrument.

Phrases and terms similar to “financial institution,” “transaction account issuer,” “issuer system,” “payment network,” or the like may include any entity that offers transaction account services. Although often referred to as a “financial institution,” the financial institution may represent any type of bank, lender, or other type of account issuing institution, such as credit card companies, card sponsoring companies, or third party issuers under contract with financial institutions. It is further noted that other participants may be involved in some phases of the transaction, such as an intermediary settlement institution.

The phrases “consumer,” “customer,” “user,” “account holder,” “account affiliate,” “cardmember,” or the like shall include any person, entity, business, government organization, business, software, hardware, machine associated with a transaction account, who buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

As used herein, “big data” may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

A record of charge (or “ROC”) may comprise any transaction or transaction data. The ROC may be a unique identifier associated with a transaction. Record of Charge (ROC) data includes important information and enhanced data. For example, a ROC may contain details such as location, merchant name or identifier, transaction amount, transaction date, account number, account security pin or code, account expiry date, and the like for the transaction. Such enhanced data increases the accuracy of matching the transaction data to the receipt data. Such enhanced ROC data is NOT equivalent to transaction entries from a banking statement or transaction account statement, which is very limited to basic data about a transaction. Furthermore, a ROC is provided by a different source, namely the ROC is provided by the merchant to the transaction processor. In that regard, the ROC is a unique identifier associated with a particular transaction. A ROC is often associated with a Summary of Charges (SOC). The ROCs and SOCs include information provided by the merchant to the transaction processor, and the ROCs and SOCs are used in the settlement process with the merchant. A transaction may, in various embodiments, be performed by a one or more members using a transaction account, such as a transaction account associated with a gift card, a debit card, a credit card, and the like.

Distributed computing cluster may be, for example, a HADOOP® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, UNIX®, LINUX®, SOLARIS®, MACOS®, etc.) as well as various conventional support software and drivers typically associated with computers.

The present system, or any part(s) or function(s) thereof, may be implemented using hardware, software, or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by artificial intelligence (AI) or machine learning. Artificial intelligence may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In various embodiments, the embodiments are directed toward one or more computer systems capable of carrying out the functionalities described herein. The computer system includes one or more processors. The processor is connected to a communication infrastructure (e.g., a communications bus, cross-over bar, network, etc.). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random access memory (RAM), and may also include a secondary memory. The secondary memory may include, for example, a hard disk drive, a solid-state drive, and/or a removable storage drive. The removable storage drive reads from and/or writes to a removable storage unit in a well-known manner. As will be appreciated, the removable storage unit includes a computer usable storage medium having stored therein computer software and/or data.

In various embodiments, secondary memory may include other similar devices for allowing computer programs or other instructions to be loaded into a computer system. Such devices may include, for example, a removable storage unit and an interface. Examples of such may include a program cartridge and cartridge interface (such as that found in video game devices), a removable memory chip (such as an erasable programmable read only memory (EPROM), programmable read only memory (PROM)) and associated socket, or other removable storage units and interfaces, which allow software and data to be transferred from the removable storage unit to a computer system.

The terms “computer program medium,” “computer usable medium,” and “computer readable medium” are used to generally refer to media such as removable storage drive and a hard disk installed in hard disk drive. These computer program products provide software to a computer system.

The computer system may also include a communications interface. A communications interface allows software and data to be transferred between the computer system and external devices. Examples of communications interface may include a modem, a network interface (such as an Ethernet card), a communications port, a Personal Computer Memory Card International Association (PCMCIA) slot and card, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

Any communication, transmission, communications channel, channel, and/or the like discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word™ or EXCEL®, an ADOBE® Portable Document Format (PDF) document, etc.), an “ebook,” an “emagazine,” an application or microapplication (as described herein), an SMS or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, QZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS® applications, webpages, websites, web forms, prompts, etc. Practitioners will appreciate that the illustrated steps described herein may comprise in any number of configurations including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, software may be stored in a computer program product and loaded into a computer system using removable storage drive, hard disk drive, or communications interface. The control logic (software), when executed by the processor, causes the processor to perform the functions of various embodiments as described herein. In various embodiments, hardware components may take the form of application specific integrated circuits (ASICs). Implementation of the hardware state machine so as to perform the functions described herein will be apparent to persons skilled in the relevant art(s).

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

In various embodiments, the system may implement middleware to provide software applications and services, and/or to bridge software components in the computer based system, such as the operating system, database, applications, and the like. Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQTM (formerly MQSeries) by IBM®, Inc. (Armonk, N.Y.) is an example of a commercially available middleware product. An Enterprise Service Bus (“ESB”) application is another example of middleware.

The systems, computers, computer based systems, and the like disclosed herein may provide a suitable website or other internet-based graphical user interface which is accessible by users. Practitioners will appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT And XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. As a further example, representational state transfer (REST), or RESTful, web services may provide one way of enabling interoperability between applications.

In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

In various embodiments, the server may include application servers (e.g. WEBSPHERE®, WEBLOGIC®, JBOSS®, POSTGRES PLUS ADVANCED SERVER®, etc.). In various embodiments, the server may include web servers (e.g. Apache, IIS, GOOGLE® Web Server, SUN JAVA® System Web Server, JAVA® Virtual Machine running on LINUX® or WINDOWS® operating systems).

Users, systems, computer based systems or the like may communicate with the server via a web client. The web client includes any device or software which communicates via any network, such as, for example any device or software discussed herein. The web client may include internet browsing software installed within a computing unit or a system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EXPLORER® software, MOZILLA® FIREFOX® software, GOOGLE® CHROME® software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, internet of things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network. For more information on distributed ledgers implementing features and functionalities of blockchain, see U.S. application Ser. No. 15/266,350 titled SYSTEMS AND METHODS FOR BLOCKCHAIN BASED PAYMENT NETWORKS and filed on Sep. 15, 2016, U.S. application Ser. No. 15/682,180 titled SYSTEMS AND METHODS FOR DATA FILE TRANSFER BALANCING AND CONTROL ON BLOCKCHAIN and filed Aug. 21, 2017, U.S. application Ser. No. 15/728,086 titled SYSTEMS AND METHODS FOR LOYALTY POINT DISTRIBUTION and filed Oct. 9, 2017, U.S. application Ser. No. 15/785,843 titled MESSAGING BALANCING AND CONTROL ON BLOCKCHAIN and filed on Oct. 17, 2017, U.S. application Ser. No. 15/785,870 titled API REQUEST AND RESPONSE BALANCING AND CONTROL ON BLOCKCHAIN and filed on Oct. 17, 2017, U.S. application Ser. No. 15/824,450 titled SINGLE SIGN-ON SOLUTION USING BLOCKCHAIN and filed on Nov. 28, 2017, U.S. application Ser. No. 15/824,513 titled TRANSACTION AUTHORIZATION PROCESS USING BLOCKCHAIN and filed on Nov. 28, 2017, U.S. application Ser. No. 15/943,168 titled TRANSACTION PROCESS USING BLOCKCHAIN TOKEN SMART CONTRACTS and filed on Apr. 2, 2018, and U.S. application Ser. No. 15/943,271 titled FRAUD MANAGEMENT USING A DISTRIBUTED DATABASE and filed on Apr. 2, 2018, the contents of which are each incorporated by reference in its entirety.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database, system, device, server, and/or other component includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic-curve cryptography (e.g., ECC, ECDH, ECDSA, etc.), and/or other post-quantum cryptography algorithms under development.

A firewall may include any hardware and/or software suitably configured to protect CMS components and/or enterprise computing resources from users of other networks. Further, the firewall may be configured to limit or restrict access to various systems and components behind the firewall for web clients connecting through a web server. The firewall may reside in varying configurations including Stateful Inspection, Proxy based, access control lists, and Packet Filtering among others. The firewall may be integrated within a web server or any other CMS components or may further reside as a separate entity. The firewall may implement network address translation (“NAT”) and/or network address port translation (“NAPT”). The firewall may accommodate various tunneling protocols to facilitate secure communications, such as those used in virtual private networking. The firewall may implement a demilitarized zone (“DMZ”) to facilitate communications with a public network such as the internet. The firewall may be integrated as software within an internet server, any other application server components or may reside within another computing device or may take the form of a standalone hardware component.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C #, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like. Cryptography and network security methods are well known in the art, and are covered in many standard texts.

In various embodiments, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, SONY BLU-RAY DISC®, optical storage devices, magnetic storage devices, and/or the like.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

The disclosure and claims do not describe only a particular outcome of validating partner files, but the disclosure and claims include specific rules for implementing the outcome of validating partner files and that render information into a specific format that is then used and applied to create the desired results of validating partner files, as set forth in McRO, Inc. v. Bandai Namco Games America Inc. (Fed. Cir. case number 15-1080, Sep. 13, 2016). In other words, the outcome of validating partner files can be performed by many different types of rules and combinations of rules, and this disclosure includes various embodiments with specific rules. While the absence of complete preemption may not guarantee that a claim is eligible, the disclosure does not sufficiently preempt the field of validating partner files at all. The disclosure acts to narrow, confine, and otherwise tie down the disclosure so as not to cover the general abstract idea of just validating partner files. Significantly, other systems and methods exist for validating partner files, so it would be inappropriate to assert that the claimed invention preempts the field or monopolizes the basic tools of validating partner files. In other words, the disclosure will not prevent others from validating partner files, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims.

Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for validating a partner file, comprising:
receiving, by a validation engine in electronic communication with a partner entity system, a partner file selection indicating a location of the partner file in the partner entity system;
interrogating, by the validation engine, the partner file locally on the partner entity system to determine a data element in the partner file;
performing, by the validation engine, a format validation on the data element to determine whether at least one of the data element or the partner file is formatted according to a file specification;
performing, by the validation engine, a data validation on the data element to determine whether the data element comprises data according to the file specification; and
generating, by the validation engine, a validation report comprising data indicating an error in the data element detected during at least one of the format validation or the data validation.

2. The method of claim 1, further comprising retrieving, by the validation engine, a format validation parameter based on the data element of the partner file, wherein the format validation parameter comprises at least one of a partner file format specification, a partner file requirement type parameter, a data element order parameter, a data element requirement type parameter, a defined data element characteristic, or a custom format parameter.

3. The method of claim 2, wherein the performing the format validation comprises determining whether at least one of data or metadata from the data element matches the format validation parameter.

4. The method of claim 1, further comprising retrieving, by the validation engine, a data validation parameter based on the data element of the partner file, wherein the data validation parameter comprises at least one of a data definition parameter, a data correlation parameter, or a custom data parameter.

5. The method of claim 4, wherein the performing the data validation comprises determining whether data from the data element matches the data validation parameter.

6. The method of claim 1, further comprising parsing, by the validation engine, the partner file to determine whether the partner file is empty or unreadable.

7. The method of claim 1, wherein the partner file comprises at least one of a profile file, a daily file, or a cycle file.

8. A system for validating a partner file, comprising:
a processor; and
a tangible, non-transitory memory configured to communicate with the processor,
the tangible, non-transitory memory having instructions stored thereon that, in response to execution by the processor, cause a validation engine to perform operations comprising:
receiving, by the validation engine in electronic communication with a partner entity system, a partner file selection indicating a location of the partner file in the partner entity system;
interrogating, by the validation engine, the partner file locally on the partner entity system to determine a data element in the partner file;
performing, by the validation engine, a format validation on the data element to determine whether at least one of the data element or the partner file is formatted according to a file specification;
performing, by the validation engine, a data validation on the data element to determine whether the data element comprises data according to the file specification; and
generating, by the validation engine, a validation report comprising data indicating an error in the data element detected during at least one of the format validation or the data validation.

9. The system of claim 8, further comprising retrieving, by the validation engine, a format validation parameter based on the data element of the partner file, wherein the format validation parameter comprises at least one of a partner file format specification, a partner file requirement type parameter, a data element order parameter, a data element requirement type parameter, a defined data element characteristic, or a custom format parameter.

10. The system of claim 9, wherein the performing the format validation comprises determining whether at least one of data or metadata from the data element matches the format validation parameter.

11. The system of claim 8, further comprising retrieving, by the validation engine, a data validation parameter based on the data element of the partner file, wherein the data validation parameter comprises at least one of a data definition parameter, a data correlation parameter, or a custom data parameter.

12. The system of claim 11, wherein the performing the data validation comprises determining whether data from the data element matches the data validation parameter.

13. The system of claim 8, further comprising parsing, by the validation engine, the partner file to determine whether the partner file is empty or unreadable.

14. The system of claim 8, wherein the partner file comprises at least one of a profile file, a daily file, or a cycle file.

15. An article of manufacture including a non-transitory, tangible computer readable storage medium having instructions stored thereon that, in response to execution by a computer based system, cause the computer based system to perform operations comprising:
receiving, by the computer based system in electronic communication with a partner entity system, a partner file selection indicating a location of a partner file in the partner entity system;
interrogating, by the computer based system, the partner file locally on the partner entity system to determine a data element in the partner file;
performing, by the computer based system, a format validation on the data element to determine whether at least one of the data element or the partner file is formatted according to a file specification;
performing, by the computer based system, a data validation on the data element to determine whether the data element comprises data according to the file specification; and
generating, by the computer based system, a validation report comprising data indicating an error in the data element detected during at least one of the format validation or the data validation.

16. The article of manufacture of claim 15, further comprising retrieving, by the computer based system, a format validation parameter based on the data element of the partner file, wherein the format validation parameter comprises at least one of a partner file format specification, a partner file requirement type parameter, a data element order parameter, a data element requirement type parameter, a defined data element characteristic, or a custom format parameter.

17. The article of manufacture of claim 16, wherein the performing the format validation comprises determining whether at least one of data or metadata from the data element matches the format validation parameter.

18. The article of manufacture of claim 15, further comprising retrieving, by the computer based system, a data validation parameter based on the data element of the partner file, wherein the data validation parameter comprises at least one of a data definition parameter, a data correlation parameter, or a custom data parameter.

19. The article of manufacture of claim 18, wherein the performing the data validation comprises determining whether data from the data element matches the data validation parameter.

20. The article of manufacture of claim 15, further comprising parsing, by the computer based system, the partner file to determine whether the partner file is empty or unreadable.
